(19) United States
(12) Patent Application Publication
(10) Pub. No.: US 2012/0254998 A1
(43) Pub. Date: Oct. 4, 2012

(54) METHOD FOR BLOCKING THE EXECUTION OF A HACKING PROCESS

(76) Inventors: Jae Hwang Lee, Bucheon-si (KR); Young Hwan Kim, Dalseo-gu (KR); Dong Woo Shin, Bupyeong-gu (KR)

(21) Appl. No.: 13/394,112

(22) PCT Filed: Jul. 29, 2010
(86) PCT No.: PCT/KR2010/004982

§ 371 Date: May 15, 2012

(30) Foreign Application Priority Data
Sep. 3, 2009 (KR) 10-2009-0083015

(51) Int. Cl. G06F 21/00

(52) U.S. Cl. 726/22

(57) ABSTRACT

The present invention discloses a method of blocking the execution of a hacking process. In the method, a security process selects a process to be tested. The security process extracts the pattern of the process to be tested and compares it with hack diagnosis references. If the pattern of the process to be tested is included in the hack diagnosis references, the security process determines that the process to be tested is a hacking process. The security process calculates the unique hash value of the hacking process and compares it with hack blocking references. If the unique hash value of the hacking process is included in the hack blocking references, the security process blocks the execution of the hacking process, and, if the unique hash value of the hacking process is not included in the hack blocking references, the security process does not block the execution of the hacking process.

### TECHNICAL FIELD

The present invention relates, in general, to a method of a security process blocking the execution of a hacking process, and, more particularly, to a method of a security process, which has been executed on a computer, dualizing hack diagnosis references and hack blocking references, diagnosing at least one hacking program including a game hack, and blocking the execution of the hacking program.

### BACKGROUND ART

With the wide popularization of ultrahigh-speed Internet, the online game population has rapidly increased and a plurality of online games has been developed. However, the recognition and perceptions of game security are still very weak. Illegal programs in computers are called hacks or hacking programs, and hacks or hacking programs in games are called game hacks. The game hacks are referred to as programs used to fabricate the files or memory of specific game processes.

Such a game hack enables gamers to easily win the game by replacing specific data, such as ability or strength, increasing the speed of a blow or the number of blows in the case of a fighting game, or providing macro functions in such a way as to fabricate the memory of a game. Therefore, gamers want to install a game hack when they play an online game. However, the use of a game hack in an online game may cause problems such as breaking down the balance between users and overweight loads on the game server. That is, with regard to an online game, if some users play the game while gaining the upper hand thanks to illegal methods, the balance with other users is lost, and the balance of the entire online game is lost in critical situations, so that a game server becomes overloaded.

Therefore, game providers request gamers to install a security program together with a corresponding game so that a security process is operated when the game process is operated, and the execution of the game process is blocked if the execution of the security process is stopped. That is, when the online game is played, the security process is executed together with the game process, so that the security process blocks game hacks.

In the description of the present invention, ‘game hacks’, ‘programs’ and ‘files’ mean the collection of commands sequentially written in order to be executed on a computer, and ‘processes’ refer to programs which are executed in the computer. That is, game programs function as the game processes and are executed on the gamer's computer, the security programs function as the security processes and are executed on the gamer's computer, and such a security process blocks the execution of various kinds of hacking processes including game hacks executed on the computer.

The security process should not block all processes executed when a gamer is playing a game. That is, in order to play the game, a system process, a game process, and a security process should be essentially executed, and the execution of processes which are not hacking processes should be permitted.

In the description of the present invention, the system process, the game process, and the security process are commonly called essential processes, and processes which are not the essential processes are called general processes. The illegal, general processes, such as game hacks, which should be blocked are called hacking processes, and the general processes which are not hacking processes and whose execution should be permitted are called non-hacking processes.

The security process allows the execution of such an essential process from among the processes which are being executed on a computer, diagnoses whether such a general process is a hacking process or a non-hacking process. If, as a result of the diagnosis, the general process is determined to be a hacking process, the security process blocks the execution thereof, and, if the general process is determined to be a non-hacking process, the security process allows the execution thereof.

Generally, most gamers want to use game hacks but do not have ability to directly develop the game hacks. Therefore, game hack developers, who develop game hacks and sell charged game hacks to the gamers, have appeared.

The game hack developers develop new game hacks which are not blocked by security processes and sell them to gamers. When the gamers use the new game hacks, a security company analyzes the new game hacks and updates security programs so that the security processes block the new game hacks.

FIG. 1 is a diagram showing a process of updating a game hack and a security program between a game hack developer, gamers, and a security company.

The game hack developer develops a new game hack which is not blocked by a security process, and uploads it to a distribution server at step S11. Thereafter, the new game hack is downloaded to a plurality of gamer computers and then used at step S12. The security company collects the sample of the new game hack used by the gamers at step S13, analyzes it at step S14, and updates a security program for blocking the corresponding game hack at step S15. Thereafter, the security company distributes the updated security program to the gamer computers so that the security program updated in each of the gamer computers blocks the new game hack at step S16. When the game hack is blocked by the security program, the game hack developers analyze standards used by the corresponding security process to block the new game hack, and detect a method of dodging the block standards at step S17. Thereafter, the process returns to step S11 at which the game hack developer develops a new game hack using the detected method and uploads the new game hack to the distribution server. With regard to online games, the security company should keep up a war to update game hacks and security programs against the plurality of game hack developers.

Generally, with regard to the security process, the diagnosis standards used to diagnose game hacks are the same as the blocking standards used to block the game hacks. That is, the security process diagnoses whether a general process which is being executed on a computer is a game hack or not, and, if the general process is determined to be a game hack, the security process blocks the execution of the corresponding hacking process.

In the early stages of a new game hack being used on the gamer computers, the security process does not diagnose it as a game hack and wrongly diagnoses it as a non-hacking process, thereby permitting the execution of the corresponding hacking process. When the security company analyzes the pattern of a new version of the game hack and updates the security process, the security process diagnoses the game hack as a game hack and then blocks it.

Therefore, in the early stages of a new game hack being used on the gamer computers, the security process cannot recognize it as a game hack, so that a large amount of effort and time are consumed in order for the security company to collect and analyze the sample of the new version of the game hack. In contrast, the game hack developers update the game hack using an easy method, and test whether the updated game hack evades the security process, and provide a new version of the game hack, which evades the security process, to the gamers. Here, although the game hack is a program which was written in the same pattern of code, the game hack becomes a new version of a game hack even if it is newly compiled.

There is a problem in that the security company needs to use a large amount of effort and time in order to collect the sample of a corresponding game hack and to set up patterns used to diagnose a game hack whenever a new version of the game hack is developed and released. When viewed from the standpoint of the security company, it is very important to reduce the time consumed to collect patterns used to diagnose a game hack.

### DISCLOSURE OF THE INVENTION

Accordingly, the present invention has been made keeping in mind the above problems occurring in the prior art, and an object of the present invention is to provide a method of blocking the execution of a hacking process, which dualizes the hack diagnosis references and hack blocking references of a security process, so that game hack developers cannot easily recognize the hack diagnosis references because the game hack developers can easily evade the hack blocking references of the security process, thereby easily diagnosing new game hacks.

In order to accomplish the above object, a method of blocking the execution of a hacking process according to an embodiment of the present invention includes a first step of a security process selecting a process to be tested from among processes which are being executed on a computer; a second step of the security process extracting the pattern of the process to be tested and comparing it with hack diagnosis references; a third step of, if, as a result of the comparison at the second step, the pattern of the process to be tested is included in the hack diagnosis references, the security process determining that the process to be tested is a hacking process; a fourth step of the security process calculating the unique hash value of the hacking process and comparing it with hack blocking references; a fifth step of, if, as a result of the comparison at the fourth step, the unique hash value of the hacking process is included in the hack blocking references, the security process blocking the execution of the hacking process, and, if the unique hash value of the hacking process is not included in the hack blocking references, the security process not blocking the execution of the hacking process.

Further, a method of blocking the execution of a hacking process according to another embodiment of the present invention includes: a first step of a security process selecting a process to be tested from among processes which are being executed on a computer; a second step of the security process calculating the unique hash value of the process to be tested and comparing it with hack blocking references; a third step of, if, as a result of the comparison at the second step, the unique hash value of the process to be tested is included in the hack blocking references, the security process blocking execution of the process to be tested; a fourth step of, if, as the result of the comparison at the second step, the unique hash value of the process to be tested is not included in the hack blocking references, the security process allowing the execution of the process to be tested, extracting the pattern of the process to be tested, and comparing the extracted pattern with hack diagnosis references; and a fifth step of, if, as a result of the comparison at the fourth step, the pattern of the process to be tested is included in the hack diagnosis references, the security process recognizing the process to be tested as a new hacking process, and transmitting the unique hash value of the new hacking process to a security server.

Further, a method of blocking the execution of a hacking process according to further another embodiment of the present invention includes: a first step of a security process selecting a process to be tested from among processes which are being executed on a computer; a second step of the security process calculating the unique hash value of the process to be tested and comparing it with hack blocking references; a third step of, if, as a result of the comparison at the second step, the unique hash value of the process to be tested is included in the hack blocking references, the security process blocking execution of the process to be tested; a fourth step of, if, as the result of the comparison at the second step, the unique hash value of the process to be tested is not included in the hack blocking references, the security process allowing the execution of the process to be tested, extracting the pattern of the process to be tested, and comparing the extracted pattern with hack diagnosis references; and a fifth step of, if, as a result of the comparison at the fourth step, the pattern of the process to be tested is included in the hack diagnosis standard, the security process blocking the execution of the process to be tested alter a critical time has elapsed.

As described above, since the present invention allows game hack developers to easily evade the hack blocking references of a security process so that the game hack developers release a new game hack while not modifying the pattern of the game hack, there is an advantage in that a security company can easily diagnose whether the new game hack is a game hack, and in that the amount of effort and time required to diagnose the game hack can be reduced.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing a process of updating a game hack and a security program between game hack developers, gamers, and a security company;

FIG. 2 is a diagram showing a system for blocking the execution of a hacking process, to which the present invention is applied; and

FIG. 3 is a flowchart showing a method of blocking the execution of the hacking process according to an embodiment of the present invention.

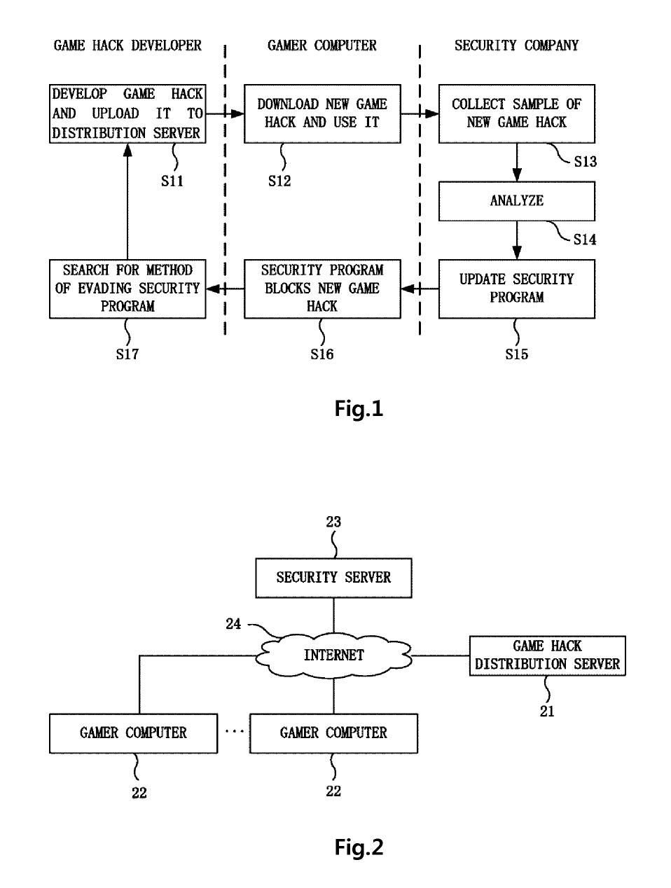

### BEST MODE FOR CARRYING OUT THE INVENTION

A method of blocking the execution of a hacking process according to an embodiment of the present invention will be described in detail with reference to the accompanying drawings below.

FIG. 2 is a diagram showing a system for blocking the execution of a hacking process, to which the present invention is applied.

Depending on the intention of a gamer, a game hack is downloaded to a gamer computer 22 from a game hack distribution server 21. Of course, a security program is downloaded and installed on the gamer computer 22, together with a game program. The security program is periodically or intermittently updated by a security server 23.

When the gamer executes the game program, the security program is automatically executed. The security process executed by the gamer computer 22 determines whether at least one general process executed in the gamer computer is a hacking process or a non-hacking process by applying hack diagnosis references, and determines whether the general process is a process to be blocked or a process not to be blocked by applying hack blocking references. Preferably, in the present invention, the hack diagnosis references are based on the pattern of the game hack, and the hack blocking references are based on the unique hash value of the game hack.

Even though a general process which is being executed in the gamer computer is determined to be a hacking process, the security process does not block the corresponding hacking process if the general process is not a process to be blocked. Instead, the security process recognizes the general process as a new hacking process, calculates the unique hash value of the game hack of the new hacking process, transmits the calculated unique hash value to the security server, and waits until the unique hash value of the corresponding new hacking process is included in the hack blocking references.

If the number of gamers who use a game hack having the same unique hash value is larger than a critical value, the security server updates the security program by adding the corresponding unique hash value to the hack blocking references, and downloads the updated security program to the gamer computer in conformity with a security policy. Further, if a critical time period has elapsed after the game hack having a corresponding unique hash value was accepted for the first time, the security server updates the security program by adding the corresponding unique hash value to the hack blocking references, and downloads the updated security program to the gamer computer in conformity with the security policy. Even through the hack blocking references are not updated by the security server, the security process may recognize the corresponding new hacking process, add the unique hash value of the corresponding new hacking process to the hack blocking references after the critical time has elapsed, and then block the execution of the corresponding hacking process.

Of course, since the security process does not block a game hack for a predetermined time period even though the security process diagnoses the corresponding game hack, the present invention is shown as if it is not different from the conventional method when viewed from the outside. However, according to the present invention, game hack developers can evade the hack blocking references of the security process using a very easy method (for example, a method of compiling a game hack again). In that case, a newly complied game hack (the pattern of the new game hack is the same as the pattern of the existing game hack) is distributed to the gamers again, and the security process can immediately diagnose the corresponding game hack based on the pattern even without collecting the sample of the game hack. That is, when viewed from the standpoint of the security company, the time consumed to collect and analyze the pattern of a game hack can be reduced.

If a new version of a game hack is distributed, 12 to 24 hours are consumed to collect and analyze the corresponding game hack and a plurality of gamers may use the new version of the game hack during that time period. The present invention does not aim to completely prevent the gamers from using the new version of the game hack but aim to induce the game hack developers to distribute the new version of the game hack without modifying the pattern of the game hack, thereby reducing the effort and time consumed by the security company in order to diagnose the game hack.

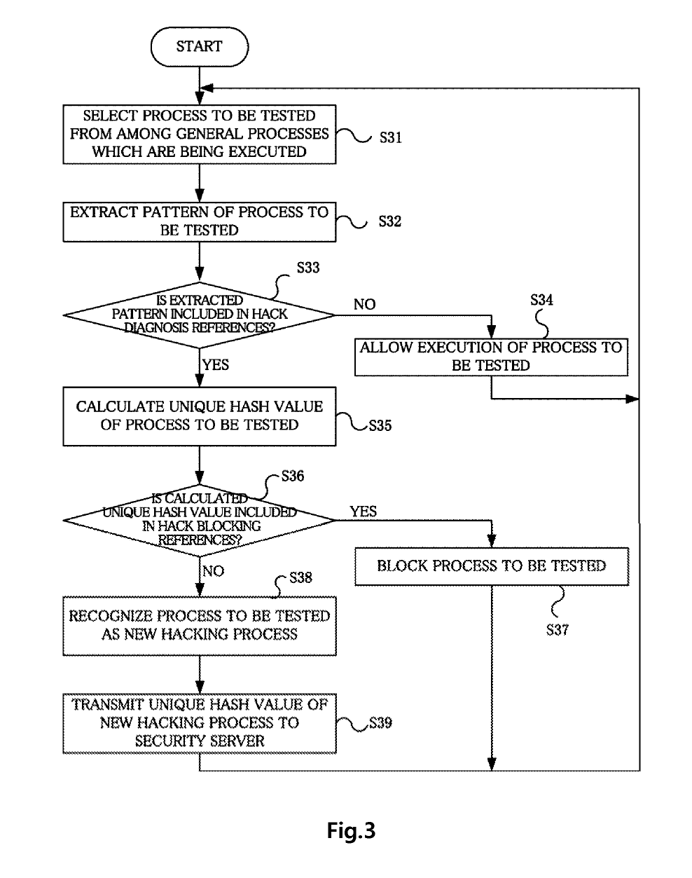

FIG. 3 is a flowchart showing a method of a security process blocking a hacking process according to an embodiment of the present invention.

If the security process is executed, one of general processes which are being executed on a computer is selected as a process to be tested at step S31, the pattern of the selected process to be tested is extracted at step S32, and it is determined whether the extracted pattern of the process to be tested is included in hack diagnosis references at step S33.

If, as a result of the determination at step S33, the pattern of the process to be tested is not included in the hack diagnosis references, the corresponding process to be tested is recognized as a non-hacking process and the execution of the corresponding non-hacking process is allowed at step S34.

If, as the result of the determination at step S33, the pattern of the process to be tested is included in the hack diagnosis references, the process to be tested is diagnosed as a hacking process. However, the execution of all the diagnosed hacking processes is not blocked, the unique hash value of the process to be tested is calculated at step S35, and it is determined whether the calculated unique hash value is included in the hack blocking references at step S36.

If, as a result of the determination at step S36, the unique hash value of the process to be tested exists in the hack blocking references, the corresponding process to be tested is recognized as a hacking process to be blocked and the execution of the hacking process to be blocked is blocked at step S37.

If, as the result of the determination at step S36, the unique hash value of the process to be tested does not exist in the hack blocking references, the corresponding process to be tested is recognized as a new hacking process at step S38 and the unique hash value of the corresponding new hacking process is sent to a security server at step S39.

Here, the unique hash value of the new hacking process may be obtained by calculating the hash value of the entirety or a partial portion of the hacking process loaded to memory, or obtained by calculating the hash value of the entirety or a partial portion of a hack file which is responsible for the execution of the new hacking process.

Further, when the unique hash value of the new hacking process is sent to the security server, it is preferable that the security process transmit the unique hash value after encoding it.

Here, the hack diagnosis references include a plurality of characteristic patterns of the hacking processes. The security process recognizes the process to be tested as a hacking process when the process to be tested includes all the characteristic patterns included in the hack diagnosis references, and the security process recognizes the process to be tested as a hacking process when the process to be tested includes at least part of the plurality of characteristic patterns included in the hack diagnosis references.

Steps S31 to S39 are repeatedly performed on all the executing processes.

When the unique hash value of a new hacking process is input from the security process of the gamer computer, the security server updates the security program by adding the unique hash value of the new hacking process to the hack blocking references based on the number of gamers who use the new hacking process or based on the time that has elapsed since the new hacking process was initially detected in conformity with a security policy. If the unique hash value of the new hacking process is added to the hack blocking references, the security process blocks the execution of the corresponding new hacking process. Otherwise, the security process of the gamer computer can blocks the execution of the corresponding new hacking process by adding the unique hash value of the new hacking process to the hack blocking references if a critical time elapses since the new hacking process was detected.

Further, the pattern of the process to be tested is detected and compared with the hack diagnosis references, and then the unique hash value of the process to be tested is calculated and compared with the hack blocking references in FIG. 3. However, the present invention is not limited thereto, and the unique hash value of the process to be tested may be calculated and compared with the hack blocking references, and then the pattern of the process to be tested may be detected and compared with the hack diagnosis references.

Although the technical spirit of the present invention has been described with reference to the attached drawings, this is related to the most preferred embodiments of the present invention that have been exemplarily described, and the present invention is not limited thereto. Further, those skilled in the art will appreciate that various modifications and variations are possible without departing from the scope of the technical spirit of the invention.

What is claimed is:

1. A method of blocking an execution of a hacking process, the method comprising:
a first step of a security process selecting a process to be tested from among processes which are being executed on a computer;
a second step of the security process extracting a pattern of the process to be tested and comparing it with hack diagnosis references;
a third step of, if, as a result of the comparison at the second step, the pattern of the process to be tested is included in the hack diagnosis references, the security process determining that the process to be tested is a hacking process;
a fourth step of the security process calculating a unique hash value of the hacking process and comparing it with hack blocking references;
a fifth step of, if, as a result of the comparison at the fourth step, the unique hash value of the hacking process is included in the hack blocking references, the security process blocking execution of the hacking process, and, if the unique hash value of the hacking process is not included in the hack blocking references, the security process not blocking the execution of the hacking process.

2. The method according to claim 1, further comprising a sixth step of, if, as the result of the comparison at the second step, the pattern of the process to be tested is not included in the hack diagnosis references, the security process determining that the process to be tested is a nonhacking process and allowing execution of the process to be tested.

3. The method according to claim 1, wherein the fourth step is configured to calculate a hash value of at least some parts of the hacking process which has been loaded to memory, and set the calculated hash value to be the unique hash value of the hacking process.

4. The method according to claim 1, wherein the fourth step is configured to calculate a hash value of at least some parts of a file which is responsible for the execution of the hacking process, and set the calculated hash value to be the unique hash value of the hacking process.

5. The method according to claim 1, wherein the fifth step comprises, if, as the result of the comparison at the fourth step, the unique hash value of the hacking process is not included in the hack blocking references, the security process determining that the hacking process is a new hacking process, and transmitting a unique hash value of the new hacking process to a security server.

6. The method according to claim 5, wherein the security process encodes the unique hash value of the new hacking process, and then transmits the encoded unique hash value to the security server.

7. The method according to claim 5, wherein the security server adds the unique hash value of the new hacking process to the hack blocking references if a number of times the unique hash value of the new hacking process has been transmitted is equal to or larger than a critical value.

8. The method according to claim 5, wherein the security server adds the unique hash value of the new hacking process to the hack blocking references if a critical time has elapsed after receiving the unique hash value of the new hacking process.

9. The method according to claim 1, wherein the fifth step comprises, if, as the result of the comparison at the fourth step, the unique hash value of the hacking process is not included in the hack blocking references, the security process determining that the hacking process is a new hacking process, and blocking execution of the new hacking process after a critical time has elapsed.

10. A method of blocking an execution of a hacking process, the method comprising:
a first step of a security process selecting a process to be tested from among processes which are being executed on a computer;
a second step of the security process calculating a unique hash value of the process to be tested and comparing it with hack blocking references;
a third step of, if, as a result of the comparison at the second step, the unique hash value of the process to be tested is included in the hack blocking references, the security process blocking execution of the process to be tested;
a fourth step of, if, as the result of the comparison at the second step, the unique hash value of the process to be tested is not included in the hack blocking references, the security process allowing the execution of the process to be tested, extracting a pattern of the process to be tested, and comparing the extracted pattern with hack diagnosis references; and
a fifth step of, if, as a result of the comparison at the fourth step, the pattern of the process to be tested is included in the hack diagnosis references, the security process recognizing the process to be tested as a new hacking process, and transmitting a unique hash value of the new hacking process to a security server.

11. The method according to claim 10, wherein the security server adds the unique hash value of the new hacking process to the hack blocking references if a number of times the unique hash value of the new hacking process has been transmitted is equal to or larger than a critical value.

12. The method according to claim 10, wherein the security server adds the unique hash value of the new hacking process to the hack blocking references if a critical time has elapsed after receiving the unique hash value of the new hacking process.

13. The method according to claim 10, wherein the security process encodes the unique hash value of the new hacking process and transmits the encoded unique hash value to the security server.

14. A method of blocking an execution of a hacking process, the method comprising:
a first step of a security process selecting a process to be tested from among processes which are being executed on a computer;
a second step of the security process calculating a unique hash value of the process to be tested and comparing it with hack blocking references;
a third step of, if, as a result of the comparison at the second step, the unique hash value of the process to be tested is included in the hack blocking references, the security process blocking execution of the process to be tested;
a fourth step of, if, as the result of the comparison at the second step, the unique hash value of the process to be tested is not included in the hack blocking references, the security process allowing the execution of the process to be tested, extracting a pattern of the process to be tested, and comparing the extracted pattern with hack diagnosis references; and
a fifth step of, if, as a result of the comparison at the fourth step, the pattern of the process to be tested is included in the hack diagnosis standard, the security process blocking the execution of the process to be tested after a critical time has elapsed.

15. The method according to claim 14, wherein the second step is configured to calculate a hash value of at least some parts of the process to be tested which has been loaded to memory, and set the calculated has value to be the unique hash value of the process to be tested.

16. The method according to claim 14, wherein the second step is configured to calculate a hash value of at least some parts of a file which are responsible for execution of the process to be tested, and set the calculated hash value to be the unique hash value of the process to be tested.
